(19) United States
(12) Patent Application Publication
(10) Pub. No.: US 2017/0372254 A1
(43) Pub. Date: Dec. 28, 2017

(54) EVENT SCHEDULE OPTIMIZER SYSTEM

(71) Applicants: Oded Vainas, Petah Tiqwa (IL); Omri Mendels, Tel Aviv (IL); Avi Samoucha, Tel Aviv (IL); Tal Marian, Tel Aviv (IL)

(72) Inventors: Oded Vainas, Petah Tiqwa (IL); Omri Mendels, Tel Aviv (IL); Avi Samoucha, Tel Aviv (IL); Tal Marian, Tel Aviv (IL)

(21) Appl. No.: 15/193,725

(22) Filed: Jun. 27, 2016

(51) Int. Cl. G06Q 10/06; H04L 29/08; G06Q 10/10

(52) U.S. Cl. CPC G06Q 10/063116; G06Q 10/1093; H04L 67/18

(57) ABSTRACT

An event schedule optimizer system includes a user interface, an invitees extractor, a time optimizer, and a place optimizer. The user interface is to receive data input from an organizer and provide data output to the organizer. The invitees extractor is to generate an intended invitees list including intended invitees for a target event based on the data input from the organizer. The time optimizer is to determine an optimal time period for the target event based on a list of historical events of the organizer. The place optimizer is to determine an optimal place for the target event based on a set of proposed times and the list of historical events of the organizer.

### TECHNICAL FIELD

Embodiments described herein generally relate to networking, and in particular, to an event schedule optimizer system.

### BACKGROUND

In a busy corporate world, people are often involved in several meetings throughout a given business day. In addition, people are often involved in other events, both personal and professional, that also are scheduled on their calendars. Busy people who are on the go and don't have convenient access to their calendars, address books, and logs of prior meetings and events often are not able to schedule meetings and events until they get back to their office or other location where they do have convenient access to their calendars, address books, and logs of prior meetings and events. However, being able to schedule meetings and events on the go is paramount to maintaining business and operational efficiency for busy people. Various techniques may be used by a meeting organizer to schedule attendees.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings, in which:

FIG. 1 is a block diagram illustrating an event schedule management system, according to an embodiment:

FIG. 2 is a block diagram illustrating an event schedule optimizer system, according to an embodiment;

FIG. 3 is a block diagram illustrating a schedule optimizer, according to an embodiment;

FIG. 4 is a flowchart illustrating a method for optimizing an event schedule, according to an embodiment:

FIG. 5 is a block diagram illustrating a schedule optimizer, according to an embodiment; and

FIG. 6 is a block diagram illustrating an example machine upon which any one or more of the techniques (e.g., methodologies) discussed herein may perform, according to an example embodiment.

### DETAILED DESCRIPTION

In the following description, for purposes of explanation, numerous specific details are set forth in order to provide a thorough understanding of some example embodiments. It will be evident, however, to one skilled in the art that the present disclosure may be practiced without these specific details.

Disclosed herein are systems and methods that provide an event schedule optimizer system. With the emergence of mobile and wearable devices, new functionality has become more readily available. Many devices include sophisticated processors, radios, and other circuitry that provide notifications, location tracking, and near real time communications. Such functionality may be leveraged to improve event scheduling for a user or event organizer. Through various device location services, e.g., via WiFi, the Global Positioning System (GPS), and cell towers, the user's activity schedule and places frequented may be inferred using the user's mobile or wearable device. Using near real time communications between the user's mobile or wearable device and a scheduling application, the user may schedule events when on the go using information about the user's inferred activity schedule and frequented places. The scheduling application may be considered a type of artificial personal assistant that schedules an event for the user by identifying a best time for the event according to the user's calendar and the calendars of invitees, in addition to other factors and information. An available time slot is only one of many factors that one needs to consider when scheduling an event. Different people have different scheduling preferences and not every available time slot is suitable for every event. In addition, scheduling events using wearable devices, e.g., wrist watches and head-worn devices, presents multiple user interface and user experience challenges, especially when the user is in constant motion, leading to an increased potential for ambiguous input by the user. The scheduling application provides technological advances to address problems of a user in trying to schedule events using a mobile or wearable device when on the go, including the ambiguous input provided by the user. The technological advancements facilitate generating a list of intended invitees for a target event based on at least the input from the user, even when the input is ambiguous; determining an optimal time period for the target event based on at least a list of the user's historical events; and determining an optimal place for the target event based on at least a proposed time and the list of the user's historical events.

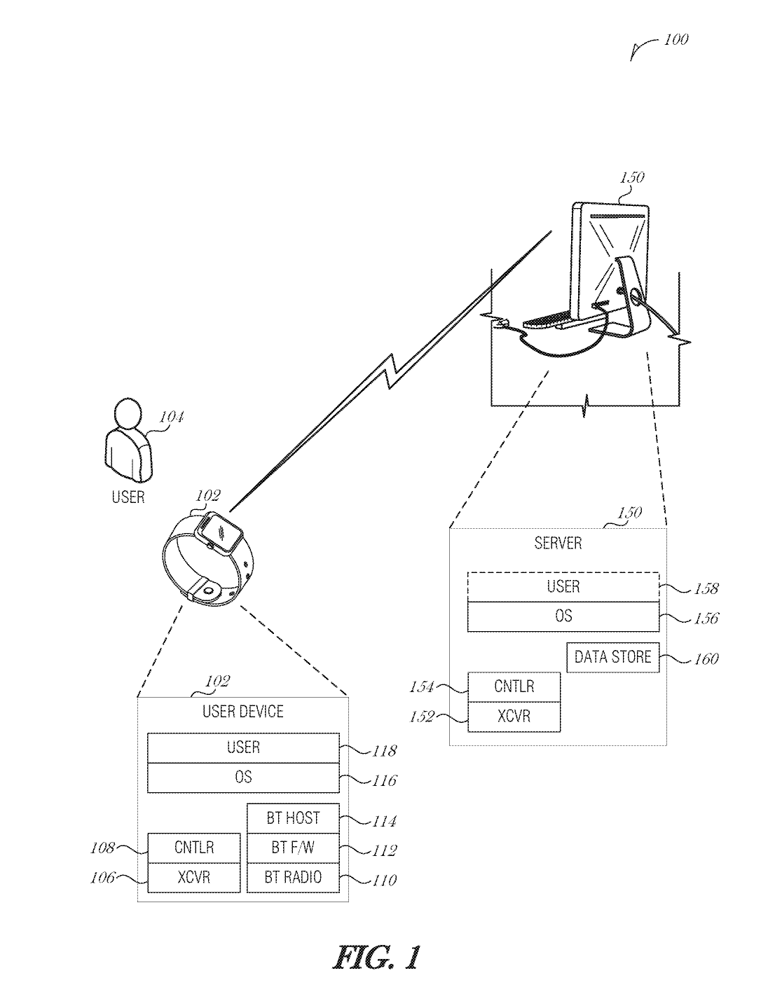

FIG. 1 is a block diagram illustrating an event schedule management system 100, according to an embodiment. The event schedule management system 100 may include a user device 102 and a server 150. The event schedule management system 100 may be installed and executed at a local site, such as at an office or hospital, or installed and executed from a remote site, such as a data center or a cloud service. Portions of the event schedule management system 100 may run locally while other portions may run remotely (with respect to the local elements).

The user device 102 may be any type of electronic or computing device, including but not limited to a laptop, smartphone, wearable device, tablet, hybrid device, or the like. The user device 102 includes a transceiver 106, capable of both sending and receiving data, and controlled by a controller 108. The transceiver 106 and controller 108 may be used to communicate over various wireless networks, such as a Wi-Fi network (e.g., according to the IEEE 802.11 family of standards); cellular network, such as a network designed according to the Long-Term Evolution (LTE), LTE-Advanced, 5G, or Global System for Mobile Communications (GSM) families of standards; or the like.

The user device 102 may include Bluetooth hardware, firmware, and software to enable Bluetooth connectivity according to the IEEE 802.15 family of standards. In an example, the user device 102 includes a Bluetooth radio 110 controlled by Bluetooth firmware 112 and a Bluetooth host 114.

An operating system 116 interfaces with the controller 108 and Bluetooth host 114. The operating system 116 may be a desktop operating system, embedded operating system, real-time operating system, proprietary operating system, network operating system, and the like. Examples include, but are not limited to, Windows® NT (and its variants), Windows® Mobile, Windows® Embedded, Mac OS®, Apple iOS, Apple WatchOS®, UNIX, Android™, JavaOS, Symbian OS, Linux, and other suitable operating system platforms.

A communication controller (not shown) may be implemented in hardware, in firmware, or in the operating system 116. The communication controller may act as an interface with various hardware abstraction layer (HAL) interfaces, such as device drivers, communication protocol stacks, libraries, and the like. The communication controller is operable to receive user input (e.g., from a system event or by an express system call to the communication controller), and interact with one or more lower-level communication devices (e.g., Bluetooth radio, Wi-Fi radio, cellular radio, etc.) based on the user input. The communication controller may be implemented, at least in part, in a user-level application that makes calls to one or more libraries, device interfaces, or the like in the operating system 116, to cause communication devices to operate in a certain manner.

A user application space 118 on the user device 102 is used to implement user-level applications, controls, user interfaces, and the like, for a user 104 to control the user device 102. An application, app, extension, control panel, or other user-level executable software program may be used to control access to the user device 102. For example, an executable file, such as an app, may be installed on the user device 102 and operable to communicate with a host application installed on the server 150.

The server 150 may include an operating system, a file system, database connectivity, radios, or other interfaces to provide an event schedule optimizer system to the user device 102. In particular the server 150 may include, or be communicatively connected to, a radio transceiver 152 to communicate with the user device 102. A respective controller 154 may control the radio transceiver 152 of the server 150, which in turn is connected with and controlled via an operating system 156 and user-level applications 158.

In operation, the user 104 is able to schedule one or more meetings or other events. The details of the events are stored at the server 150. The details include the event time, place, invitees, description, and the like. Invitees may have various statuses, such as required invitees or optional invitees. The server 150 may store the event details in a data store 160. The data store 160 may be located at the server 150 or at a remote server (e.g., a database server). The server 150 may provide a reminder to the user 104 about the scheduled event, such as with a notification or other mechanism. The server 150 may also receive location information from the user device 102, which may be transmitted on a recurring or periodic basis, on demand, or by other means. The location information may be used by the server 150 to determine the location of the user device 102 and inferentially the location of the user 104 of the user device 102. Based on the location information, the server 150 may determine details of the user's status. Further details are provided in the following figures and description.

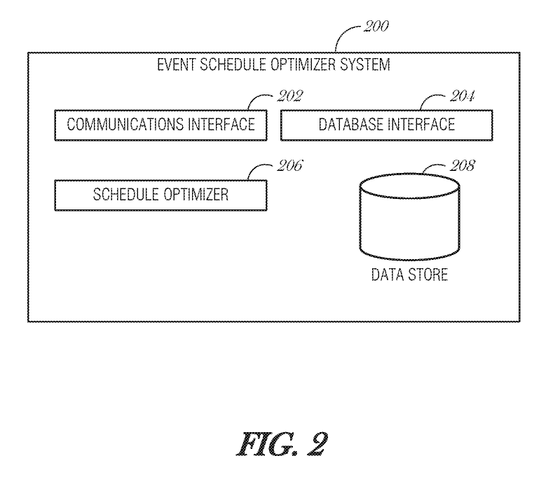

FIG. 2 is a block diagram illustrating an event schedule optimizer system 200, according to an embodiment. The event schedule optimizer system 200 includes a communications interface 202, a database interface 204, and a schedule optimizer 206. The database interface 204 is used to access a data store 208, which may be co-located with the event schedule optimizer system 200 or remote from the event schedule optimizer system 200.

The communications interface 202, database interface 204, and schedule optimizer 206 are understood to encompass tangible entities that are physically constructed, specifically configured (e.g., hardwired), or temporarily (e.g., transitorily) configured (e.g., programmed) to operate in a specified manner or to perform part or all of any operations described herein. Such tangible entities may be constructed using one or more circuits, such as with dedicated hardware (e.g., field programmable gate arrays (FPGAs), logic gates, graphics processing units (GPUs), digital signal processors (DSPs), etc.). As such, the tangible entities described herein may be referred to as circuits, circuitry, processor units, subsystems, or the like.

The communications interface 202 may be coupled to one or more radio transmitters, and may communicate with a user device, e.g., an embodiment of the user device 102. The user device may be associated with a user, and the location of the user device may correspond with a location of the user. The communications interface 202 may access data from the user device, and may provide data to the user device.

The database interface 204 may be configured to access a database of scheduled events for the user, including past or historical events, present events, and prospective or future events. The database interface 204 may also be configured to provide data to the database of scheduled events for the user, and also to access data from a location-based database, e.g., a database of places where events take place or a map.

The schedule optimizer 206 may be coupled to the communications interface 202 and the database interface 204, and configured to optimize an event schedule using data from the communications interface 202 and/or the database interface 204.

There are generally three main input parameters that are used to schedule an event: the start time, the names of the invitees (e.g., those people invited to attend, or attendees), and the place or location where the event will be held. Generally, given these input parameters, the availability of the invitees may be examined, and the details of the event may be edited accordingly, or the invitations may be sent to the invitees. In embodiments as described herein, the scheduling process is complemented using technological innovations to utilize an in-depth understanding of routines of the user and the invitees, as well as a record of past events involving both the user and the invitees, to improve the suitability of the initial proposed event schedule for the user and the invitees, and thereby shorten the scheduling process without additional input from the user. Furthermore, in the embodiments, the user may schedule events while on the go and not completely available to perform all the tasks conventionally required for a user to perform in order to schedule an event.

For example, the user may be driving, riding a bicycle, jogging, skiing, etc., and be able to schedule events using the embodiments described herein. In these scenarios, the user may provide limited and ambiguous input, for example through voice recognition, and the schedule optimizer 206 may infer the information to be used for scheduling the event as intended by the user from the limited and ambiguous input. When the user is scheduling the event using a wearable device, e.g., a smart watch or headset, the user may provide input for scheduling the event conveniently through voice recognition. The schedule optimizer 206 may be able to infer intended invitees for the event to be scheduled, i.e., a target event, from the information input by the user by evaluating matching information in the user's past or historical scheduled events, already scheduled prospective or future events, contacts database, email logs, or other data stored in a database, e.g., the data store 208. The matching information may include information in metadata associated with scheduled events, for example. Likewise, the schedule optimizer 206 may be able to infer other information including a start time for the target event, a duration of the target event, and a place for the target event. Generally, the schedule optimizer 206 may follow an operational flow from determining the intended invitees from the user's input, to determining an optimal time for the user and the intended invitees to attend the event, to determining an optimal place for the event. Each of these three stages of the operational flow may be based on an unsupervised (e.g., automatic) artificial intelligence or machine learning algorithm and method, e.g., an expert system or a decision support system. In some situations, the user may be requested to provide additional input to resolve ambiguities in order for the schedule optimizer 206 to complete the event scheduling process.

For example, the schedule optimizer 206 may access data including a list of historical events through the database interface 204 and analyze the list of historical events to identify historical patterns of events that included both the user and the intended invitees, such as the time and place where meetings between the user and the intended invitees usually have been scheduled, e.g., in the morning, only on weekends, only at work, if in the morning then at work, if in the evening then at home, etc.

The schedule optimizer 206 may also infer additional semantic information regarding the target event. For example, the schedule optimizer 206 may infer whether an invitee is related to a specific place, e.g., the user's work. The schedule optimizer 206 may also infer whether the user meets with the invitee individually, or along with other people, and whether those other people should also be invited to the target event if they have not already been identified as invitees. The schedule optimizer 206 may also infer where the user usually meets with a specific invitee, or whether the user usually meets virtually (e.g., by telephone, teleconference, or webinar), or physically at a specific place. In addition, the schedule optimizer 206 may infer information from the user's data (e.g., the user's list of historical events or email logs) to compensate for an invitee's calendar being invisible to the user (and the schedule optimizer 206).

Furthermore, the schedule optimizer 206 may determine a type of relationship between the user and an invitee, and determine a meeting time and place according to this type of relationship. For example, the schedule optimizer 206 may determine that the invitee is an insurance salesperson and not related to the user's work, and therefore the schedule optimizer 206 may attempt to schedule a meeting between the insurance salesman and the user in the evening after the user's work hours, and may schedule the meeting at the insurance salesperson's office or at the user's home, depending upon any past meetings between the user and the insurance salesperson or other insurance salespeople with whom the user may have had previous meetings.

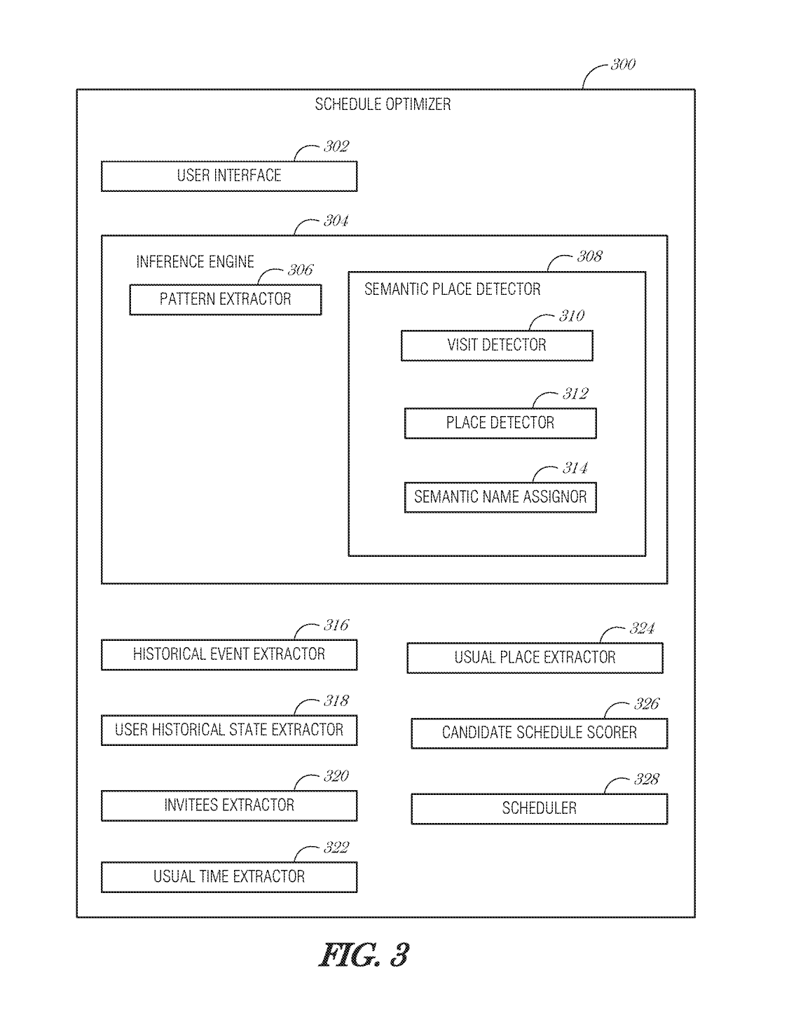

FIG. 3 is a block diagram illustrating a schedule optimizer 300, according to an embodiment. The schedule optimizer 300 may be an embodiment of the schedule optimizer 206. The schedule optimizer 300 may include a user interface 302, an inference engine 304, a historical event extractor 316, a user historical state extractor 318, an invitees extractor 320, a usual time extractor 322, a usual place extractor 324, a candidate schedule scorer 326, and a scheduler 328.

The user interface 302 may be configured to receive data input from a user 104, and to provide data output to the user 104. The user interface 302 may receive data input from the user 104 via the user's user device 102, which may be a mobile device. The user device 102 may also be a wearable device. In some embodiments, the user interface 302 may also receive input from the user 104 via a desktop computer or server, e.g., the server 150. The user interface 302 may receive data input from the user 104 using voice recognition.

The inference engine 304 may infer desired data from input from the user 104 and/or data accessed via the database interface 204. The inference engine 304 may also infer parameters for scheduling the target event, including usual and preferential day, time, location, and frequency of events to be scheduled. The inference engine 304 may include a pattern extractor 306 and a semantic place detector 308.

The pattern extractor 306 may detect routines and/or patterns in the user historical event list and/or user device data. The pattern extractor 306 may employ statistical models to detect routines, patterns, and out-of-routine behavior to infer meaning regarding the usual work hours of the user 104 on different days of the week, when the user 104 is usually out of the office, and the locations or places associates with the user's home and work. The pattern extractor 306 may assign semantics or meaning to various events, places, and/or people (e.g., potential invitees) in the user's life.

The semantic place detector 308 may detect and assign semantics or meaning to places that the user 104 has recurrently visited based on the user 104's historical events and/or user device data. The semantic place detector 308 may include a visit detector 310, a place detector 312, and a semantic name assignor 314.

The visit detector 310 may generate a list of locations visited by the user 104 using at least one of GPS data, WiFi data, and cell tower data of the user device 102 of the user 104. The visit detector 310 may ignore false positives, e.g., traffic lights and traffic jams. For example, the visit detector 310 may identify that the user 104 has been engaged in the activity of driving or riding transportation at the time the user 104 has stopped moving, and then resumes moving after a short while (e.g., a few minutes), and therefore is likely to be at a stoplight or in a traffic jam or the like.

The place detector 312 may generate a list of places including the locations visited by the user 104 that have meaning to the user 104. Out of the user's visits as determined by the visit detector 310, the place detector 312 infers which have some meaning to the user 104, e.g., the user's home, the user's work, the user's gym, the user's parents' home, etc. The place detector 312 may use information obtained via the database interface 204, e.g., from the user's contacts database, to make these inferences, in addition to inspecting the user's recurrent visits and stay routines as determined by the visit detector 310.

The semantic name assignor 314 may assign semantics or meaning to one or more of the places in the list of places based on data input from the user 104, the scheduled events of the user 104, and/or data from a location-based database, contacts database, or electronically stored map. The semantic name assignor 314 may assign the semantics according to a hierarchy of different places, e.g., residential/nonresidential, city, address, business (e.g., Joe's gym), place frequented by the user 104 (e.g., user's home, user's gym, user's work, etc.). The semantic name assignor 314 may give preference to more specific levels of the hierarchy for purposes of determining a definite place for the target event, but may evaluate places on different levels of the hierarchy of different places according to commonalities between the different places in the list of places.

The historical event extractor 316 may generate a user historical event list including the historical events of the user 104. The historical event extractor 316 may also extract from each user historical event of the user historical event list at least one event attribute. The event attribute may include a list of invitees (e.g., both required and optional), a list of attendees, a scheduled time (e.g., start time and duration), a subject, and a scheduled place for each of the historical events of the user 104. The historical event extractor 316 may also generate a list of the extracted event attributes, for example, a list of all invitees or attendees, a list of event times, a list of event subjects, and a list of event places. The historical event extractor 316 may also correlate the lists of extracted event attributes with one another.

The user historical state extractor 318 may identify a usual routine of the user 104. The user historical state extractor 318's identifying the usual routine of the user 104 may include identifying a usual working schedule of the user 104. The user historical state extractor 318 may use the inference engine 304 to identify the usual working schedule of the user 104. The user historical state extractor 318 may use at least one of WiFi data, GPS data, and cell tower data of the user device 102 of the user 104 to identify the usual working schedule of the user 104. The user historical state extractor 318 may also use at least one of WiFi data. GPS data and cell tower data of the user device 102 of the user 104 to identify the usual routine of the user 104, which may include exercise, waking and sleeping hours, and other activities in addition to working. The user historical state extractor 318 may also use the inference engine 304 to identify the usual routine of the user 104. In addition, the user historical state extractor 318 may determine both ordinary and outlier days in terms of their routines, and identify the usual working hours of the user 104 on each day of the week.

The invitees extractor 320 may generate an intended invitees list including intended invitees for a target event. The invitees extractor 320 may extract an initial list of intended invitees from an input received from the user 104, which the user 104 may input using voice recognition via the user device 102. The input received from the user 104 may be ambiguous, and therefore the initial list of intended invitees extracted by the invitees extractor 320 may also have ambiguous entries. The invitees extractor 320 may also filter out events without any of the intended invitees from the user historical event list. The filtered user historical event list would then include only events having at least one of the intended invitees. The invitees extractor 320 may additionally identify a usual working schedule of each intended invitee in the intended invitees list. The invitees extractor 320 may use the inference engine 304 to identify the usual working schedule of each intended invitee in the intended invitees list. The invitees extractor 320 may use the inference engine 304 to generate the intended invitees list from an ambiguous list of intended invitees for the target event. The invitees extractor 320 may use the inference engine 304 to infer additional invitees based at least on the intended invitees for the target event. The invitees extractor 320 may use the inference engine 304 to also infer additional invitees based on one or more of the subject of the event, the place of the event, the start time of the event, the duration of the event, and the user historical event list.

The usual time extractor 322 may, for each intended invitee in the intended invitees list, identify a usual time period when the user 104 usually had a historical event including the intended invitee based on a time period hierarchy of work hours, usual one or more days of a week, usual one or more parts of a day (e.g., morning, noon, evening, night), usual one or more hours of a day, and usual specific time and duration of time. The usual time extractor 322 may use the inference engine 304 to identify the usual time period when the user 104 usually had a historical event including the intended invitee. The usual time extractor 322 may further identify a usual time period when the user 104 usually had a historical event including all of the intended invitees based on the time period hierarchy. The usual time extractor 322 may use the inference engine 304 to further identify the usual time period when the user 104 usually had a historical event including all of the intended invitees based on the time period hierarchy. The usual time extractor 322 may give preference to more specific levels of the time period hierarchy for purposes of determining candidate time periods for the target event, but may evaluate time periods on different levels of the time period hierarchy according to commonalities between the different events in the list of historical events. The usual time extractor 322 may use the inference engine 304 to identify a usual frequency of user historical events including each individual intended invitee and/or all of the intended invitees.

The usual place extractor 324 may, for each intended invitee in the intended invitees list, identify one or more usual places where the user 104 usually had a historical event including the intended invitee. The usual place extractor 324 may use at least one of GPS data, WiFi data, and cell tower data of the user device 102 to identify one or more usual meeting places of the user 104 overall. The usual place extractor 324 may use the inference engine 304 to identify the one or more usual meeting places of the user 104 overall. The usual place extractor 324 may use at least one of GPS data, WiFi data, and cell tower data of the user device 102 to identify the one or more usual places where the user 104 usually had a historical event including the intended invitee. The usual place extractor 324 may use the inference engine 304 and the semantic place detector 308 to identify the one or more usual meeting places of the user 104 with the intended invitee.

The candidate schedule scorer 326 may assign a score to each of one or more of the following: candidate start times, candidate durations, candidate places, candidate subjects, and candidate invitees. A candidate time period may include both the candidate start time and the candidate duration. The scores may be assigned based on the current state or activity of the user 104, the usual routine of the user 104 for both ordinary and outlier days including the user's usual working hours for each day of the week as determined by the user historical state extractor 318, the filtered user historical event list, the usual time period when the user 104 usually had a historical event including each intended invitee based on the time period hierarchy, and/or the usual place where the user 104 usually had a historical event including each intended invitee according to one or more of the semantics of place (e.g., residential/nonresidential, city, address, business (e.g., Joe's gym), place frequented by the user 104 (e.g., user's home, user's gym, user's work), etc. The candidate schedule scorer 326 may also determine one or more candidate event schedules and associated candidate event schedule scores for the target event. Each of the one or more candidate event schedules may include a selected candidate start time based on the score assigned to the one or more candidate start times, a selected candidate duration based on the score assigned to the one or more candidate durations, a selected candidate place based on the score assigned to the one or more candidate places, and one or more selected candidate invitees based on the score assigned to the one or more candidate invitees. The candidate schedule scorer 326 may use the inference engine 304 to determine whether the target event is related to a specific place or activity of the user 104. The candidate schedule scorer 326 may use the inference engine 304 to infer a candidate place based on at least a candidate start time. The candidate schedule scorer 326 may use the inference engine 304 to infer a candidate start time based on at least a candidate place. The candidate schedule scorer 326 may use the inference engine 304 to infer a candidate place based on at least the list of intended invitees. The candidate schedule scorer 326 may use the inference engine 304 to infer a candidate start time based on at least the list of intended invitees.

The scheduler 328 may schedule the target event according to the assigned one or more scores of the candidate schedule scorer 326. If one of the candidate event schedules has an associated candidate event schedule score greater than the others of the one or more candidate event schedules and greater than a predetermined candidate event schedule score threshold, the scheduler 328 may schedule the candidate event schedule with the highest score as the target event.

Alternatively, if none of the candidate event schedules has an associated candidate event schedule score greater than the predetermined candidate event schedule score threshold, the scheduler 328 may present one or more of the one or more candidate event schedules to the user 104 via the user interface 302 for clarification and/or selection for scheduling. The scheduler 328 may then schedule the target event according to instructions from the user 104. For example, the scheduler 328 may schedule a candidate event as a meeting with Jeff at work for 30 minutes starting at 9:30 am if the score for the candidate schedule exceeds the threshold and is higher than any other potential candidate schedules. If the score for the candidate schedule does not exceed the threshold to be scheduled without further user involvement, the scheduler 328 may present the candidate schedule to the user 104 for clarification via the user interface 302 (e.g., “a meeting with Jeff at work for 30 minutes starting at 9:30 am”) and wait for confirmation or revision by the user 104. The scheduler 328 may present multiple candidate schedules to the user 104 for selection by the user 104.

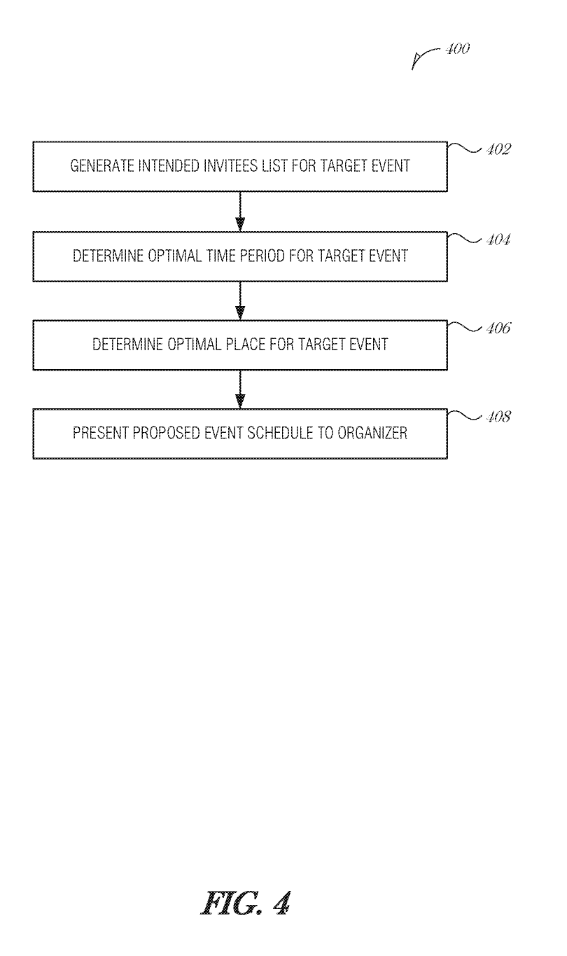

FIG. 4 is a flowchart illustrating a method 400 for optimizing an event schedule, according to an embodiment. In an operation 402, an intended invitees list including one or more intended invitees for a target event is generated based on at least input from an organizer of the target event. The intended invitees list may be generated based additionally on a list of historical events of the organizer. Generating the intended invitees list may also include inferring one or more intended invitees from the list of historical events of the organizer based on at least the input from the organizer. Inferring the intended invitees may include determining a score associated with each of a plurality of candidate invitees from the list of historical events of the organizer, and also comparing the scores associated with each of the candidate invitees with one another. The scores associated with each of the candidate invitees may also be compared against a threshold to determine whether the candidate invitees should automatically be accepted as intended invitees, or whether the organizer should be asked for confirmation or clarification regarding the candidate invitees.

For example, the organizer of the target event may input ambiguous data regarding one or more intended invitees for an event that the organizer wishes to schedule. The organizer may input simply “Jeff” as an intended invitee using voice recognition via the organizer's personal computing device, for example. Then, the organizer's historical events, which may be stored in a calendar database of the organizer, may be searched or scanned for a list of matching participants, and all historical events that include the word “Jeff” (or equivalents) as an invitee or attendee may be extracted into a filtered list of the organizer's historical events. Whether any one of the matching participants in the filtered historical event list is determined to be the intended invitee for the target event may be inferred from the filtered list of the organizer's historical events using one or more of the following hints:
Frequency of events including each matching participant
Usual event time periods including each matching participant
Previous event routines relevant for scheduling the target event
Usual place in which the organizer had an event including each matching participant
Previous event places relevant for scheduling the target event

In an example in which 3 matching participants are identified in the filtered list of historical events and considered as candidates for the intended invitees, the following may be determined:

TABLE 1
Example of inferring an intended invitee from ambiguous
input

| | | Event | Event | |
|---|---|---|---|---|
| Name/Email | Occurrences | Routines | Places | Score |
| Jeff.Alpha@intel.com | 18 | Every | Work | 95% |
| | | Monday | (100%) | |
| | | (78%) | | |
| Jeffrey.Beta@intel.com | 3 | Last visit 7 | Work | 12% |
| | | months | (45%), | |
| | | ago | Home | |
| | | | (55%) | |
| Jeffarin.Delta@aol.com | 1 | No | Restaurant | 0% |
| | | routines, 1 | (100%) | |
| | | event | | |

If the score determined for a matching participant in the example illustrated in Table 1 exceeds a predetermined threshold, and is the highest score among the matching participants, the associated matching participant is selected as the intended invitee corresponding to the organizer's ambiguous input “Jeff” If no matching participant has a score that exceeds the predetermined threshold, or where there are two or more matching participants whose scores exceed the predetermined threshold, the organizer may be prompted with a request for clarification, and/or asked to select among several matching participants.

In an operation 404, an optimal time period for the target event is determined based on at least a list of historical events of the organizer. The time period includes both a start time and a time duration. Determining the optimal time period may include, for each of the intended invitees, generating a histogram of times for historical events of the organizer including the intended invitee. Determining the optimal time period may also include inferring one or more candidate event time periods based on at least the list of historical events of the organizer. The inferring of one or more candidate event time periods may also be based on the histogram of times for historical events of the organizer associated with each of the intended invitees. Determining the optimal time period may also be based on a schedule of prospective events of the organizer and a schedule of prospective events of each of the intended invitees of the intended invitees list. Determining the optimal time period may also include determining one or more proposed times based on an intersection of available time periods in each of the organizer's schedule of prospective events, each of the intended invitees' schedules of prospective events, and the one or more inferred candidate event time periods.

Three data sources may be used for determining the optimal time period for the target event. These data sources include the list of historical events of the organizer, the organizer's schedule of prospective events in the organizer's calendar database, and each intended invitee's schedule of prospective events in the intended invitee's respective calendar database. Using the list of historical events of the organizer, a histogram of time periods for historical events including each intended invitee may be generated. In addition, an inference engine may infer when the organizer would prefer to schedule the target event based on the list of historical events. For example, if the organizer has a routine of avoiding meetings in the morning, this could be taken into account when determining the optimal time period for the target event. The organizer's calendar database may be used to determine which days and hours are relevant for scheduling the target event, and each intended invitee's calendar database may be used to determine when the respective intended invitee would be available for the target event. If an intersection is found between the time periods when the organizer is inferred to desire to schedule the event and when the organizer and each of the intended invitees is available to attend the event, a candidate time period for the event may be determined according to that intersection. In a manner similar to identifying the intended invitees from ambiguous input, more than one candidate time period may be proposed, and the organizer may be queried to clarify or select a time period for the target event. Otherwise, if there are conflicts between the organizer's calendar and one or more of the intended invitees' calendars, a private message to be sent to each invitee to propose a time for the target event may be proposed and/or automatically sent. The organizer may be presented by the event schedule optimizer system with a proposed email to send to one or more intended invitees, so that the organizer need not draft the email, but only approve or refuse the proposed email. The email may be drafted to appear to come directly from the organizer, for example: “Hi Jeff, I'd like to meet today or tomorrow. When's a good time for you to meet? I can meet today at 1:00 pm to 5:30 pm, or tomorrow 11:00 am to 2:30 pm.” If the proposed email is approved, the event schedule optimizer system may send the email on behalf of the organizer. The email may be sent to appear to originate from the organizer.

In an operation 406, an optimal place for the target event is determined based on at least a proposed time and the list of historical events of the organizer. The optimal place may be determined based also on the intended invitees list. Determining the optimal place may include inferring one or more proposed places from at least the historical events of the organizer that include one or more of the intended invitees of the intended invitees list, and/or inferring the one or more proposed places from at least a schedule of prospective events of the organizer. Determining the optimal place may also include inferring a semantic place from ambiguous input from the organizer. Determining the optimal place may also be based on a current location of the organizer.

Given the filtered list of historical events of the organizer that include one or more of the intended invitees, the current location of the organizer, and a proposed time period for the target event, one or more most probable candidate places for the target event may be inferred out of a list of semantic places. The inference may be made according to a visit detection method as discussed elsewhere herein together with a semantic model of places capable of inferring candidate places based on ambiguous input from the organizer or giving meaning to the organizer's present location in the organizer's own words (e.g., home, work, gym, car, while commuting, etc.). Additionally, if it is inferred from the organizer's current location, movement, and/or calendar database that the organizer is on the way to a place with meaning to the organizer such as a place where an event is scheduled in the near future, historical events scheduled for the place where the organizer is going may be searched in the list of historical events of the organizer to determine whether historical events including one or more of the intended invitees have been held at the place where the organizer is going. This information may be used to infer whether the place where the organizer is going should be a candidate place for the target event.

In a manner similar to that discussed above with respect to inferring the intended invitees from ambiguous input, scores may be assigned to each of a plurality of candidate places. If the score determined for a candidate place exceeds a predetermined threshold, and is the highest score among the candidate places, the associated candidate place may be selected as the intended place for the target event. If no candidate place has a score that exceeds the predetermined threshold, or where there are two or more candidate places whose scores exceed the predetermined threshold, the organizer may be prompted with a request for clarification, and/or asked to select among several candidate places.

In an operation 408, one or more proposed event schedules are presented to the organizer. Once one or more candidate schedules for the target event including the intended invitees, highest scoring candidate time period(s), and highest scoring candidate place(s) have been determined, the one or more candidate schedules may be proposed to the organizer for selection and/or approval. For example, the organizer may be queried, “Would you like me to schedule a meeting with Jeff Alpha at 11:00 am for 30 minutes at work?” The organizer may also be presented with different options for the start time and the duration of the event, for example. In a text query, the organizer may be presented with a drop-down list of options for each parameter for which options are available. Alternatively, the organizer may be presented with all of the options serially by audio, and asked to choose one of the presented options by an index number or phrase. Alternatively, the organizer may be presented with all the options for each of the parameters for which options are available, and after all parameters have been chosen based on the presented options, the complete candidate schedule for the target event may be presented to the organizer for approval. In addition, any ambiguities that may remain in any of the parameters for the target event may be resolved by presenting options for the parameter to the organizer for selection or clarification. This approach to requesting the organizer for clarification or selection among options may be performed at any point in the process of scheduling a target event.

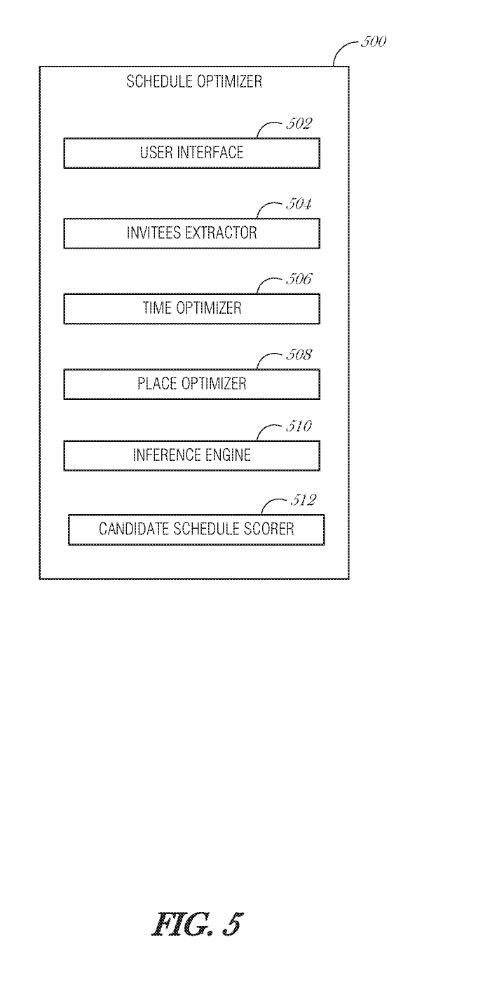

FIG. 5 is a block diagram illustrating a schedule optimizer 500, according to an embodiment. The schedule optimizer 500 may be an embodiment of the schedule optimizer 206 and/or schedule optimizer 300. The schedule optimizer 500 includes a user interface 502 configured to receive data input from an organizer, and provide data output to the organizer. The schedule optimizer 500 also includes an invitees extractor 504 configured to generate an intended invitees list including intended invitees for a target event based on at least the input from an organizer, a time optimizer 506 configured to determine an optimal time period for the target event based on at least a list of historical events of the organizer, and a place optimizer 508 configured to determine an optimal place for the target event based on at least a proposed time and the list of historical events of the organizer. The schedule optimizer 500 may also include an inference engine 510 configured to infer parameters for scheduling the target event based on at least one of input from the organizer, a list of historical events of the organizer, and a schedule of prospective events of the organizer. The schedule optimizer 500 may also include a candidate schedule scorer 512 to determine a score associated with each of a plurality of candidate attributes, including candidate start times, candidate durations, candidate places, candidate subjects, and candidate invitees. The candidate attributes may include those obtained from the list of historical events of the organizer.

In an example, an organizer tells the event schedule optimizer system 200, which may include an exemplary embodiment of the schedule optimizer 500 as an embodiment of the schedule optimizer 206, the following: “Schedule me a meeting with Jeff.” The exemplary embodiment of the schedule optimizer 500 would then determine answers to the following questions based on the list of historical events of the organizer and/or a current context of the organizer to shorten the scheduling process:
Who are the possible “Jeff”s relevant for this request by the organizer?
What is the probable time and duration for the requested meeting given the historical events?
What is the probable place for the requested meeting given past places where meetings have taken place?
Is the requested meeting related to the organizer's work? Based on this, should the requested meeting be scheduled during normal working hours?
What are the organizer's usual meeting hours?
   Based on the answers to the questions above as determined by a machine learning system, artificial intelligence system, inference engine, or the like, the event schedule optimizer system 200 may automatically schedule the organizer's requested meeting with less effort on the part of the organizer than past systems, and greater accuracy with regard to the organizer's intent, by technological improvements to overcoming ambiguities in the organizer's request compared to prior scheduling systems.

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

A processor subsystem may be used to execute the instructions on the machine-readable medium. The processor subsystem may include one or more processors, each with one or more cores. Additionally, the processor subsystem may be disposed on one or more physical devices. The processor subsystem may include one or more specialized processors, such as a GPU, a DSP, an FPGA, or a fixed function processor.

Examples, as described herein, may include, or may operate on, logic or a number of components, modules, or mechanisms. Modules may be hardware, software, or firmware communicatively coupled to one or more processors in order to carry out the operations described herein. Modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client, or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term “hardware module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

Circuitry or circuits, as used in this document, may comprise, for example, singly or in any combination, hardwired circuitry, programmable circuitry such as computer processors comprising one or more individual instruction processing cores, state machine circuitry, and/or firmware that stores instructions executed by programmable circuitry. The circuits, circuitry, or modules may, collectively or individually, be embodied as circuitry that forms part of a larger system, for example, an integrated circuit (IC), system on-chip (SoC), desktop computer, laptop computer, tablet computer, server, smart phone, etc.

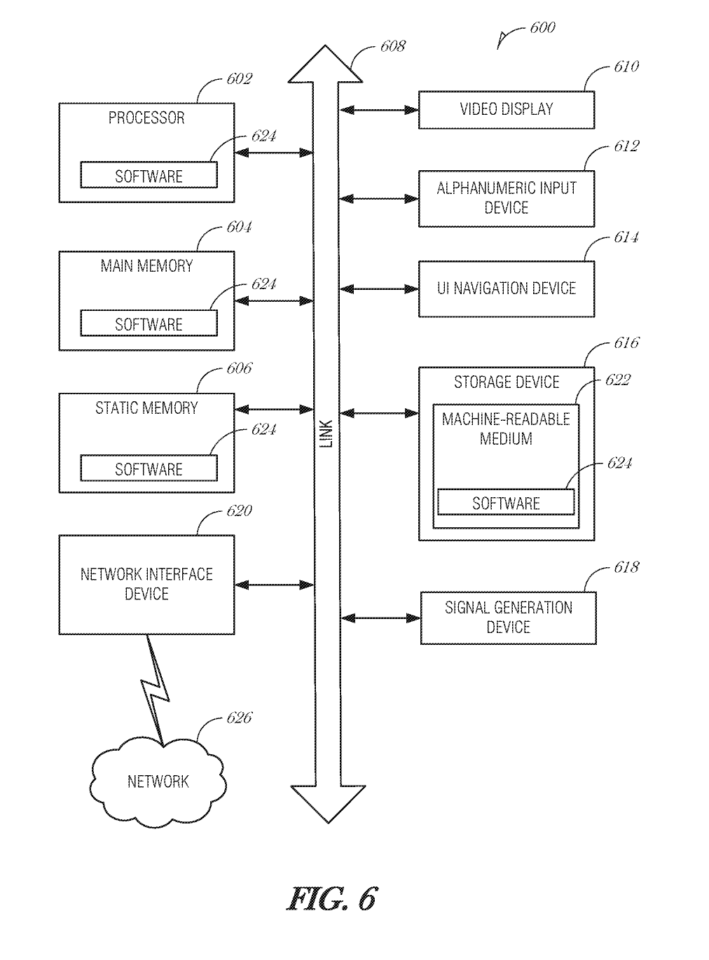

FIG. 6 is a block diagram illustrating a machine in the example form of a computer system 600, within which a set or sequence of instructions may be executed to cause the machine to perform any one or more of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be a wearable device, a personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

The computer system 600 includes at least one processor 602 (e.g., a central processing unit (CPU), a GPU, or both, processor cores, compute nodes, etc.), a main memory 604, and a static memory 606, which communicate with each other via a link 608 (e.g., bus). The computer system 600 may further include a video display unit 610, an alphanumeric input device 612 (e.g., a keyboard), and a user interface (UI) navigation device 614 (e.g., a mouse). In one embodiment, the video display unit 610, input device 612, and UI navigation device 614 are incorporated into a touch screen display. The computer system 600 may additionally include a storage device 616 (e.g., a drive unit), a signal generation device 618 (e.g., a speaker), a network interface device 620, and one or more sensors (not shown), such as a GPS sensor, compass, accelerometer, gyrometer, magnetometer, or other sensor.

The storage device 616 includes a machine-readable medium 622 on which is stored one or more sets of data structures and software 624 (e.g., instructions) embodying or utilized by any one or more of the methodologies or functions described herein. The instructions 624 may also reside, completely or at least partially, within the main memory 604, within the static memory 606, and/or within the processor 602 during execution thereof by the computer system 600, with the main memory 604, the static memory 606, and the processor 602 also constituting machine-readable media.

While the machine-readable medium 622 is illustrated in an example embodiment to be a single medium, the term “machine-readable medium” may include a single medium or multiple media (e.g., a centralized or distributed database, and/or associated caches and servers) that store the one or more instructions 624. The term “machine-readable medium” shall also be taken to include any tangible medium that is capable of storing, encoding, or carrying instructions for execution by the machine and that cause the machine to perform any one or more of the methodologies of the present disclosure, or that is capable of storing, encoding, or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 624 may further be transmitted or received over a communication network 626 using a transmission medium via the network interface device 620 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Bluetooth, Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible media to facilitate communication of such software.

Example 1 is an event schedule optimizer system, the system comprising: a user interface to: receive data input from an organizer; and provide data output to the organizer; an invitees extractor to generate an intended invitees list including intended invitees for a target event based on the data input from the organizer; a time optimizer to determine an optimal time period for the target event based on a list of historical events of the organizer; and a place optimizer to determine an optimal place for the target event based on a set of proposed times and the list of historical events of the organizer.

In Example 2, the subject matter of Example 1 optionally includes wherein the invitees extractor's generating the intended invitees list is further based on a list of historical events of the organizer, and further comprising an inference engine to infer one or more intended invitees from the list of historical events of the organizer based on the data input from the organizer.

In Example 3, the subject matter of Example 2 optionally includes a candidate schedule scorer to determine a score associated with each of a plurality of candidate invitees from the list of historical events of the organizer, the candidate invitees to be considered as candidates for the intended invitees list.

In Example 4, the subject matter of any one or more of Examples 1-3 optionally include wherein the time optimizer is further to, for each of the intended invitees, generate a histogram of times for historical events of the organizer including the intended invitee.

In Example 5, the subject matter of any one or more of Examples 1-4 optionally include an inference engine to infer one or more candidate event time periods based on the list of historical events of the organizer.

In Example 6, the subject matter of Example 5 optionally includes wherein the time optimizer's determining the optimal time period for the target event is further based on a schedule of prospective events of the organizer and a schedule of prospective events of each of the intended invitees of the intended invitees list, and the time optimizer is further to determine the one or more proposed times based on an intersection of available time periods in each of the organizer's schedule of prospective events, each of the intended invitees' schedule of prospective events, and the one or more inferred candidate event time periods.

In Example 7, the subject matter of any one or more of Examples 1-6 optionally include wherein the place optimizer's determining the optimal place is also based on the intended invitees list.

In Example 8, the subject matter of Example 7 optionally includes an inference engine to infer one or more proposed places from the historical events of the organizer that include one or more of the intended invitees of the intended invitees list.

In Example 9, the subject matter of any one or more of Examples 7-8 optionally include an inference engine to infer one or more proposed places from a schedule of prospective events of the organizer.

In Example 10, the subject matter of any one or more of Examples 7-9 optionally include an inference engine to infer a semantic place from ambiguous data input from the organizer.

In Example 11, the subject matter of any one or more of Examples 1-10 optionally include wherein the place optimizer's determining the optimal place is also based on a current location of the organizer.

Example 12 is a method of optimizing an event schedule, the method comprising: generating an intended invitees list including intended invitees for a target event based on input from an organizer; determining an optimal time period for the target event based on a list of historical events of the organizer; determining an optimal place for the target event based on a set of proposed times and the list of historical events of the organizer; and presenting a set of proposed event schedules including the intended invitees, the optimal time period, and the optimal place to the organizer.

In Example 13, the subject matter of Example 12 optionally includes wherein generating the intended invitees list is further based on the list of historical events of the organizer and includes inferring one or more of the intended invitees from the list of historical events of the organizer based on the input from the organizer.

In Example 14, the subject matter of Example 13 optionally includes wherein inferring the one or more intended invitees from the list of historical events of the organizer includes determining a score associated with each of a plurality of candidate invitees from the list of historical events of the organizer, the candidate invitees to be considered as candidates for the intended invitees list.

In Example 15, the subject matter of any one or more of Examples 12-14 optionally include wherein determining the optimal time period for the target event includes, for each of the intended invitees, generating a histogram of times for historical events of the organizer including the intended invitee.

In Example 16, the subject matter of any one or more of Examples 12-15 optionally include wherein determining the optimal time period for the target event includes inferring one or more candidate event time periods based on the list of historical events of the organizer.

In Example 17, the subject matter of Example 16 optionally includes wherein determining the optimal time period for the target event is also based on a schedule of prospective events of the organizer and a schedule of prospective events of each of the intended invitees of the intended invitees list and includes determining the one or more proposed times based on an intersection of available time periods in each of the organizer's schedule of prospective events, each of the intended invitees' schedule of prospective events, and the one or more inferred candidate event time periods.

In Example 18, the subject matter of any one or more of Examples 12-17 optionally include wherein determining the optimal place is also based on the intended invitees list.

In Example 19, the subject matter of Example 18 optionally includes wherein determining the optimal place includes inferring one or more proposed places from the historical events of the organizer that include one or more of the intended invitees of the intended invitees list.

In Example 20, the subject matter of any one or more of Examples 18-19 optionally include wherein determining the optimal place includes inferring one or more proposed places from a schedule of prospective events of the organizer.

In Example 21, the subject matter of any one or more of Examples 18-20 optionally include wherein determining the optimal place includes inferring a semantic place from ambiguous input from the organizer.

In Example 22, the subject matter of any one or more of Examples 12-21 optionally include wherein determining the optimal place is also based on a current location of the organizer.

Example 23 is at least one machine-readable medium including instructions, which when executed by a machine, cause the machine to perform operations of any of the methods of Examples 12-22.

Example 24 is an apparatus comprising means for performing any of the methods of Examples 12-22.

Example 25 is an event schedule optimizer system, the system comprising: means for generating an intended invitees list including intended invitees for a target event based on input from an organizer; means for determining an optimal time period for the target event based on a list of historical events of the organizer; means for determining an optimal place for the target event based on a proposed time and the list of historical events of the organizer; and means for presenting a set of proposed event schedules to the organizer.

In Example 26, the subject matter of Example 25 optionally includes wherein the means for generating the intended invitees list is further based on the list of historical events of the organizer and includes means for inferring one or more of the intended invitees from the list of historical events of the organizer based on the input from the organizer.

In Example 27, the subject matter of Example 26 optionally includes wherein the means for inferring the one or more intended invitees from the list of historical events of the organizer includes means for determining a score associated with each of a plurality of candidate invitees from the list of historical events of the organizer, the candidate invitees to be considered as candidates for the intended invitees list.

In Example 28, the subject matter of any one or more of Examples 25-27 optionally include wherein the means for determining the optimal time period for the target event includes means for generating a histogram of times for historical events of the organizer including the intended invitee, for each of the intended invitees.

In Example 29, the subject matter of any one or more of Examples 25-28 optionally include wherein the means for determining the optimal time period for the target event includes means for inferring one or more candidate event time periods based on the list of historical events of the organizer.

In Example 30, the subject matter of Example 29 optionally includes wherein the means for determining the optimal time period for the target event is also based on a schedule of prospective events of the organizer and a schedule of prospective events of each of the intended invitees of the intended invitees list and includes means for determining the one or more proposed times based on an intersection of available time periods in each of the organizer's schedule of prospective events, each of the intended invitees' schedule of prospective events, and the one or more inferred candidate event time periods.

In Example 31, the subject matter of any one or more of Examples 25-30 optionally include wherein the means for determining the optimal place is also based on the intended invitees list.

In Example 32, the subject matter of Example 31 optionally includes wherein the means for determining the optimal place includes means for inferring one or more proposed places from the historical events of the organizer that include one or more of the intended invitees of the intended invitees list.

In Example 33, the subject matter of any one or more of Examples 31-32 optionally include wherein the means for determining the optimal place includes means for inferring one or more proposed places from a schedule of prospective events of the organizer.

In Example 34, the subject matter of any one or more of Examples 31-33 optionally include wherein the means for determining the optimal place includes means for inferring a semantic place from ambiguous input from the organizer.

In Example 35, the subject matter of any one or more of Examples 25-34 optionally include wherein the means for determining the optimal place is also based on a current location of the organizer.

Example 36 is an event schedule optimizer system, the system comprising: a database interface to: access data from a database of scheduled events of a user, the database including prospective events and historical events; provide data to the database of scheduled events of the user; and access data from a location-based database; a communications interface to: access data from a computing device of the user; and provide data to the computing device of the user; a user interface to: receive data input from a user; and provide data output to the user; an inference engine to infer desired data from at least one of the data input from the user, the data accessed via the database interface, and the data accessed via the communications interface; a historical event extractor to: generate a user historical event list including the historical events of the user; and extract from each user historical event of the user historical event list at least one event attribute selected from the group of event attributes consisting of a list of attendees, a scheduled time, a subject, and a scheduled place for each of the historical events of the user; a user historical state extractor to identify a usual routine of the user; an invitees extractor to: generate an intended invitees list including intended invitees for a target event; and filter out historical events without any of the intended invitees from the user historical event list; a usual time extractor to, for each intended invitee in the intended invitees list, identify a usual time period when the user usually had a historical event including the intended invitee based on a time period hierarchy of work hours, usual one or more days of a week, usual one or more parts of a day, usual one or more hours of a day, and usual specific time and duration; a usual place extractor to, for each intended invitee in the intended invitees list, identify one or more usual places where the user usually had a historical event including the intended invitee; a candidate schedule scorer to: assign a score to each of one or more candidate event attributes selected from the group consisting of candidate start times, candidate durations, candidate places, candidate subjects, and candidate invitees, based on the usual routine of the user, the filtered user historical event list, the usual time period when the user usually had a historical event including each intended invitee based on the time period hierarchy, and the one or more usual places where the user usually had a historical event including each intended invitee; and determine one or more candidate event schedules and associated candidate event schedule scores for the target event, each of the one or more candidate event schedules including a selected candidate start time based on the score assigned to the one or more candidate start times, a selected candidate duration based on the score assigned to the one or more candidate durations, a selected candidate place based on the score assigned to the one or more candidate places, and one or more selected candidate invitees based on the score assigned to the one or more candidate invitees; and a scheduler to: schedule the target event according to the assigned one or more candidate event schedule scores.

In Example 37, the subject matter of Example 36 optionally includes wherein the usual place extractor further uses at least one of GPS data. WiFi data, and cell tower data of the computing device of the user to identify one or more usual meeting places of the user overall.

In Example 38, the subject matter of any one or more of Examples 36-37 optionally include wherein the usual time extractor further identifies a usual time period when the user usually had a historical event including all of the intended invitees based on the time period hierarchy.

In Example 39, the subject matter of any one or more of Examples 36-38 optionally include wherein the invitees extractor additionally identifies a usual working schedule of each intended invitee in the intended invitees list.

In Example 40, the subject matter of any one or more of Examples 36-39 optionally include wherein the invitees extractor extracts the intended invitees from the data input from the user.

In Example 41, the subject matter of any one or more of Examples 36-40 optionally include wherein the usual place extractor uses at least one of WiFi data, GPS data, and cell tower data of the computing device of the user to identify the one or more usual places where the user usually had a historical event including the intended invitee.

In Example 42, the subject matter of any one or more of Examples 36-41 optionally include wherein the user historical state extractor's identifying the usual routine of the user includes identifying a usual working schedule of the user.

In Example 43, the subject matter of Example 42 optionally includes wherein the user historical state extractor uses the inference engine to identify the usual working schedule of the user.

In Example 44, the subject matter of any one or more of Examples 42-43 optionally include wherein the user historical state extractor uses at least one of WiFi data, GPS data, and cell tower data of the computing device of the user to identify the usual working schedule of the user.

In Example 45, the subject matter of any one or more of Examples 36-44 optionally include wherein the user historical state extractor uses the inference engine to identify the usual routine of the user.

In Example 46, the subject matter of any one or more of Examples 36-45 optionally include wherein the user historical state extractor uses at least one of WiFi data. GPS data and cell tower data of the computing device of the user to identify the usual routine of the user.

In Example 47, the subject matter of any one or more of Examples 36-46 optionally include wherein the invitees extractor uses the inference engine to identify a usual working schedule of each intended invitee in the intended invitees list.

In Example 48, the subject matter of any one or more of Examples 36-47 optionally include wherein the usual time extractor uses the inference engine to identify one or more days of the week when the user usually had a historical event including the intended invitee.

In Example 49, the subject matter of any one or more of Examples 36-48 optionally include wherein the usual time extractor uses the inference engine to identify one or more parts of the day when the user usually had a historical event including the intended invitee.

In Example 50, the subject matter of any one or more of Examples 36-49 optionally include wherein the usual time extractor uses the inference engine to identify one or more usual hours of the day when the user usually had a historical event including the intended invitee.

In Example 51, the subject matter of any one or more of Examples 36-50 optionally include wherein the usual time extractor uses the inference engine to identify a usual duration of time for which the user usually had a historical event including the intended invitee.

In Example 52, the subject matter of any one or more of Examples 36-51 optionally include wherein the usual time extractor uses the inference engine to identify one or more days of the week when the user usually had a historical event including all of the intended invitees.

In Example 53, the subject matter of any one or more of Examples 36-52 optionally include wherein the usual time extractor uses the inference engine to identify one or more parts of the day when the user usually had a historical event including all of the intended invitees.

In Example 54, the subject matter of any one or more of Examples 36-53 optionally include wherein the usual time extractor uses the inference engine to identify one or more usual hours of the day when the user usually had a historical event including all of the intended invitees.

In Example 55, the subject matter of any one or more of Examples 36-54 optionally include wherein the usual place extractor uses the inference engine to identify one or more usual meeting places of the user overall.

In Example 56, the subject matter of any one or more of Examples 36-55 optionally include wherein the usual place extractor uses the inference engine to identify one or more usual meeting places of the user with the intended invitee.

In Example 57, the subject matter of any one or more of Examples 36-56 optionally include wherein the usual time extractor uses the inference engine to identify a usual frequency of user historical events including each individual intended invitee of the intended invitees.

In Example 58, the subject matter of any one or more of Examples 36-57 optionally include wherein the usual time extractor uses the inference engine to identify a usual frequency of user historical events including all of the intended invitees.

In Example 59, the subject matter of any one or more of Examples 36-58 optionally include wherein the invitees extractor uses the inference engine to generate the intended invitees list from an ambiguous list of intended invitees for the target event.

In Example 60, the subject matter of any one or more of Examples 36-59 optionally include wherein the candidate schedule scorer uses the inference engine to determine whether the target event is related to a specific place or activity of the user.

In Example 61, the subject matter of any one or more of Examples 36-60 optionally include wherein the candidate schedule scorer uses the inference engine to infer a candidate place based on a candidate start time.

In Example 62, the subject matter of any one or more of Examples 36-61 optionally include wherein the candidate schedule scorer uses the inference engine to infer a candidate start time based on a candidate place.

In Example 63, the subject matter of any one or more of Examples 36-62 optionally include wherein the candidate schedule scorer uses the inference engine to infer a candidate place based on the intended invitees list.

In Example 64, the subject matter of any one or more of Examples 36-63 optionally include wherein the candidate schedule scorer uses the inference engine to infer a candidate start time based on the intended invitees list.

In Example 65, the subject matter of any one or more of Examples 36-64 optionally include wherein the user interface receives the data input from the user using voice recognition.

In Example 66, the subject matter of any one or more of Examples 36-65 optionally include wherein the invitees extractor uses the inference engine to infer additional invitees based on at least one of the user's historical event list, a target subject, a target place, a target start time, a target duration, and the intended invitees for the target event.

In Example 67, the subject matter of any one or more of Examples 36-66 optionally include wherein the inference engine includes a pattern extractor that detects routines and/or patterns in the user historical event list and/or computing device data using statistical models.

In Example 68, the subject matter of Example 67 optionally includes wherein the pattern extractor assigns semantics to events, places, and/or invitees.

In Example 69, the subject matter of any one or more of Examples 67-68 optionally include wherein the inference engine includes a semantic place detector that detects and assigns semantics to places that the user has recurrently visited based on the user historical event list and/or computing device data.

In Example 70, the subject matter of Example 69 optionally includes wherein the semantic place detector includes: a visit detector that generates a list of locations visited by the user using at least one of GPS data. WiFi data, and cell tower data of the computing device of the user; a place detector that generates a list of places including the locations visited by the user that have meaning to the user; and a semantic name assignor that assigns semantics to one or more of the places in the list of places based on the data input from the user, the scheduled events of the user, and/or the data from the location-based database.

In Example 71, the subject matter of any one or more of Examples 36-70 optionally include wherein each of the one or more candidate event schedules determined by the candidate schedule scorer include a candidate start time and a candidate place.

In Example 72, the subject matter of Example 71 optionally includes wherein the scheduler's scheduling of the target event according to the assigned one or more scores includes: if one of the one or more candidate event schedules has an associated candidate event schedule score greater than the others of the one or more candidate event schedules and greater than a predetermined candidate event schedule score threshold, scheduling the one of the one or more candidate event schedules; and alternatively, if none of the one or more candidate event schedules has an associated candidate event schedule score greater than the predetermined candidate event schedule score threshold, presenting a set of the one or more candidate event schedules to the user for clarification and/or selection for scheduling.

Example 73 is a method of optimizing an event schedule, the method comprising: generating an intended invitees list including intended invitees for a target event; generating a user historical event list including historical events of a user; filtering out historical events without any of the intended invitees from the user historical event list; extracting from each user historical event of the user historical event list at least one event attribute selected from the group of event attributes consisting of a list of attendees, a scheduled time, a subject, and a scheduled place for each of the historical events of the user; identifying a usual routine of the user; identifying, for each intended invitee in the intended invitees list, a usual start time and/or time period when the user usually had a historical event including the intended invitee based on a time period hierarchy from work hours, usual one or more days of a week, usual one or more parts of a day, usual one or more hours of a day, and usual specific time and duration; identifying, for each intended invitee in the intended invitees list, one or more usual places where the user usually had a historical event including the intended invitee: assigning a score to each of one or more candidate event attributes selected from the group consisting of candidate start times, candidate durations, candidate places, candidate subjects, and candidate invitees, based on the usual routine of the user, the filtered user historical event list, the usual time period when the user usually had a historical event including each intended invitee based on the time period hierarchy, and the usual place where the user usually had a historical event including each intended invitee; determining one or more candidate event schedules and associated candidate event schedule scores for the target event, each of the one or more candidate event schedules including a selected candidate start time based on the score assigned to the one or more candidate start times, a selected candidate duration based on the score assigned to the one or more candidate durations, a selected candidate place based on the score assigned to the one or more candidate places, and one or more selected candidate invitees based on the score assigned to the one or more candidate invitees; and scheduling the target event according to the assigned one or more candidate event schedule scores.

In Example 74, the subject matter of Example 73 optionally includes wherein scheduling the target event includes: if one of the one or more candidate event schedules has an associated candidate event schedule score greater than the others of the one or more candidate event schedules and greater than a predetermined candidate event schedule score threshold, scheduling the one of the one or more candidate event schedules; and alternatively, if none of the one or more candidate event schedules has an associated candidate event schedule score greater than the predetermined candidate event schedule score threshold, presenting a set of the one or more candidate event schedules to the user for clarification and/or selection for scheduling.

In Example 75, the subject matter of any one or more of Examples 73-74 optionally include identifying one or more usual meeting places of the user overall.

In Example 76, the subject matter of Example 75 optionally includes wherein identifying the one or more usual meeting places of the user overall uses an inference engine.

In Example 77, the subject matter of any one or more of Examples 73-76 optionally include identifying a usual time period when the user usually had a historical event including all of the intended invitees based on the time period hierarchy.

In Example 78, the subject matter of Example 77 optionally includes wherein identifying the usual start time and/or time period when the user usually had a historical event including all of the intended invitees uses an inference engine.

In Example 79, the subject matter of any one or more of Examples 73-78 optionally include identifying a usual working schedule of each intended invitee in the intended invitees list.

In Example 80, the subject matter of any one or more of Examples 73-79 optionally include extracting the intended invitees from data input from the user.

In Example 81, the subject matter of any one or more of Examples 73-80 optionally include wherein identifying the one or more usual places where the user usually had a historical event including the intended invitee uses at least one of WiFi data, GPS data, and cell tower data of a computing device of the user.

In Example 82, the subject matter of any one or more of Examples 73-81 optionally include wherein identifying the usual routine of the user includes identifying a usual working schedule of the user.

In Example 83, the subject matter of Example 82 optionally includes wherein identifying the usual working schedule of the user uses an inference engine.

In Example 84, the subject matter of any one or more of Examples 82-83 optionally include wherein identifying the usual working schedule of the user uses at least one of WiFi data, GPS data, and cell tower data of a computing device of the user.

In Example 85, the subject matter of any one or more of Examples 73-84 optionally include wherein identifying the usual routine of the user uses an inference engine.

In Example 86, the subject matter of any one or more of Examples 73-85 optionally include wherein identifying the usual routine of the user uses at least one of WiFi data. GPS data, and cell tower data of a computing device of the user.

In Example 87, the subject matter of any one or more of Examples 73-86 optionally include identifying a usual working schedule of each intended invitee in the intended invitees list using an inference engine.

In Example 88, the subject matter of any one or more of Examples 73-87 optionally include wherein identifying the usual start time and/or time period when the user usually had a historical event including the intended invitee uses an inference engine.

In Example 89, the subject matter of any one or more of Examples 73-88 optionally include wherein identifying the one or more usual places where the user usually had a historical event including the intended invitee uses an inference engine.

In Example 90, the subject matter of any one or more of Examples 73-89 optionally include identifying a usual frequency of user historical events including each individual intended invitee using an inference engine.

In Example 91, the subject matter of any one or more of Examples 73-90 optionally include identifying a usual frequency of user historical events including all of the intended invitees using an inference engine.

In Example 92, the subject matter of any one or more of Examples 73-91 optionally include wherein generating the intended invitees list uses an inference engine to generate the intended invitees list from an ambiguous list of intended invitees for the target event.

In Example 93, the subject matter of any one or more of Examples 73-92 optionally include determining whether the target event is related to a specific place or activity of the user using an inference engine.

In Example 94, the subject matter of any one or more of Examples 73-93 optionally include inferring a candidate place based on a candidate start time.

In Example 95, the subject matter of any one or more of Examples 73-94 optionally include inferring a candidate start time based on a candidate place.

In Example 96, the subject matter of any one or more of Examples 73-95 optionally include inferring a candidate place based on the intended invitees list.

In Example 97, the subject matter of any one or more of Examples 73-96 optionally include inferring a candidate start time based on the intended invitees list.

In Example 98, the subject matter of any one or more of Examples 73-97 optionally include receiving data input from the user using voice recognition.

In Example 99, the subject matter of any one or more of Examples 73-98 optionally include inferring additional invitees based on the intended invitees for the target event.

In Example 100, the subject matter of any one or more of Examples 73-99 optionally include detecting routines and/or patterns in the user historical event list and/or computing device data using statistical models.

In Example 101, the subject matter of Example 100 optionally includes assigning semantics to events, places, and/or invitees based on the detected routines and/or patterns.

In Example 102, the subject matter of any one or more of Examples 73-101 optionally include detecting and assigning semantics to places where the user has recurrently visited based on the user historical event list and/or computing device data.

In Example 103, the subject matter of Example 102 optionally includes generating a list of locations visited by the user using at least one of GPS data. WiFi data, and cell tower data of a computing device of the user; generating a list of places including the locations visited by the user that have meaning to the user; and assigning semantics to one or more of the places in the list of places based on data input from the user, the user historical event list, and/or data from a location-based database.

In Example 104, the subject matter of any one or more of Examples 73-103 optionally include wherein each of the one or more candidate event schedules includes a candidate event start time and a candidate event place.

Example 105 is at least one machine-readable medium including instructions, which when executed by a machine, cause the machine to perform operations of any of the methods of Examples 73-104.

Example 106 is an apparatus comprising means for performing any of the methods of Examples 73-104.

Example 107 is an apparatus of providing an event schedule optimizer system, the apparatus comprising: means for generating an intended invitees list including intended invitees for a target event; means for generating a user historical event list including historical events of a user; means for filtering out historical events without any of the intended invitees from the user historical event list; means for extracting from each user historical event of the user historical event list at least one event attribute selected from the group of event attributes consisting of a list of attendees, a scheduled time, a subject, and a scheduled place for each of the historical events of the user; means for identifying a usual routine of the user; means for identifying, for each intended invitee in the intended invitees list, a usual start time and/or time period when the user usually had a historical event including the intended invitee based on a time period hierarchy from work hours, usual one or more days of a week, usual one or more parts of a day, usual one or more hours of a day, and usual specific time and duration; means for identifying, for each intended invitee in the intended invitees list, a usual place where the user usually had a historical event including the intended invitee; means for assigning a score to each of one or more candidate start times, one or more candidate durations, one or more candidate places, and one or more candidate invitees, based on the usual routine of the user, the filtered user historical event list, the usual time period when the user usually had a historical event including each intended invitee based on the time period hierarchy, and the usual place where the user usually had a historical event including each intended invitee; means for determining one or more candidate event schedules and associated candidate event schedule scores for the target event, each of the one or more candidate event schedules including a selected candidate start time based on the score assigned to the one or more candidate start times, a selected candidate duration based on the score assigned to the one or more candidate durations, a selected candidate place based on the score assigned to the one or more candidate places, and one or more selected candidate invitees based on the score assigned to the one or more candidate invitees; and means for scheduling the target event according to the assigned one or more candidate event schedule scores.

In Example 108, the subject matter of Example 107 optionally includes wherein scheduling the target event includes: means for scheduling the one of the one or more candidate event schedules if one of the one or more candidate event schedules has an associated candidate event schedule score greater than the others of the one or more candidate event schedules and greater than a predetermined candidate event schedule score threshold; and means for presenting a set of the one or more candidate event schedules to the user for clarification and/or selection for scheduling if, alternatively, none of the one or more candidate event schedules has an associated candidate event schedule score greater than the predetermined candidate event schedule score threshold.

In Example 109, the subject matter of any one or more of Examples 107-108 optionally include means for identifying one or more usual meeting places of the user overall.

In Example 110, the subject matter of Example 109 optionally includes wherein the means for identifying the one or more usual meeting places of the user overall uses an inference engine.

In Example 111, the subject matter of any one or more of Examples 107-110 optionally include means for identifying a usual time period when the user usually had a historical event including all of the intended invitees based on the time period hierarchy.

In Example 112, the subject matter of Example 111 optionally includes wherein the means for identifying the usual start time and/or time period when the user usually had a historical event including all of the intended invitees uses an inference engine.

In Example 113, the subject matter of any one or more of Examples 107-112 optionally include means for identifying a usual working schedule of each intended invitee in the intended invitees list.

In Example 114, the subject matter of any one or more of Examples 107-113 optionally include means for extracting the intended invitees from data input from the user.

In Example 115, the subject matter of any one or more of Examples 107-114 optionally include wherein the means for identifying the one or more usual places where the user usually had a historical event including the intended invitee uses at least one of WiFi data, GPS data, and cell tower data of a computing device of the user.

In Example 116, the subject matter of any one or more of Examples 107-115 optionally include wherein the means for identifying the usual routine of the user includes means for identifying a usual working schedule of the user.

In Example 117, the subject matter of Example 116 optionally includes wherein the means for identifying the usual working schedule of the user uses an inference engine.

In Example 118, the subject matter of any one or more of Examples 116-117 optionally include wherein the means for identifying the usual working schedule of the user uses at least one of WiFi data, GPS data, and cell tower data of a computing device of the user.

In Example 119, the subject matter of any one or more of Examples 107-118 optionally include wherein the means for identifying the usual routine of the user uses an inference engine.

In Example 120, the subject matter of any one or more of Examples 107-119 optionally include wherein the means for identifying the usual routine of the user uses at least one of WiFi data, GPS data, and cell tower data of a computing device of the user.

In Example 121, the subject matter of any one or more of Examples 107-120 optionally include means for identifying a usual working schedule of each intended invitee in the intended invitees list using an inference engine.

In Example 122, the subject matter of any one or more of Examples 107-121 optionally include wherein the means for identifying the usual start time and/or time period when the user usually had a historical event including the intended invitee uses an inference engine.

In Example 123, the subject matter of any one or more of Examples 107-122 optionally include wherein the means for identifying the one or more usual places where the user usually had a historical event including the intended invitee uses an inference engine.

In Example 124, the subject matter of any one or more of Examples 107-123 optionally include means for identifying a usual frequency of user historical events including each individual intended invitee using an inference engine.

In Example 125, the subject matter of any one or more of Examples 107-124 optionally include means for identifying a usual frequency of user historical events including all of the intended invitees using an inference engine.

In Example 126, the subject matter of any one or more of Examples 107-125 optionally include wherein the means for generating the intended invitees list uses an inference engine to generate the intended invitees list from an ambiguous list of intended invitees for the target event.

In Example 127, the subject matter of any one or more of Examples 107-126 optionally include means for determining whether the target event is related to a specific place or activity of the user using an inference engine.

In Example 128, the subject matter of any one or more of Examples 107-127 optionally include means for inferring a candidate place based on a candidate start time.

In Example 129, the subject matter of any one or more of Examples 107-128 optionally include means for inferring a candidate start time based on a candidate place.

In Example 130, the subject matter of any one or more of Examples 107-129 optionally include means for inferring a candidate place based on the intended invitees list.

In Example 131, the subject matter of any one or more of Examples 107-130 optionally include means for inferring a candidate start time based on the intended invitees list.

In Example 132, the subject matter of any one or more of Examples 107-131 optionally include means for receiving data input from the user using voice recognition.

In Example 133, the subject matter of any one or more of Examples 107-132 optionally include means for inferring additional invitees based on the intended invitees for the target event.

In Example 134, the subject matter of any one or more of Examples 107-133 optionally include means for detecting routines and/or patterns in the user historical event list and/or computing device data using statistical models.

In Example 135, the subject matter of Example 134 optionally includes means for assigning semantics to events, places, and/or invitees based on the detected routines and/or patterns.

In Example 136, the subject matter of any one or more of Examples 107-135 optionally include means for detecting and assigning semantics to places where the user has recurrently visited based on the user historical event list and/or computing device data.

In Example 137, the subject matter of Example 136 optionally includes means for generating a list of locations visited by the user using at least one of GPS data, WiFi data, and cell tower data of a computing device of the user; means for generating a list of places including the locations visited by the user that have meaning to the user; and means for assigning semantics to one or more of the places in the list of places based on data input from the user, the user historical event list, and/or data from a location-based database.

In Example 138, the subject matter of any one or more of Examples 107-137 optionally include wherein each of the one or more candidate event schedules includes a candidate event start time and a candidate event place.

The above Detailed Description includes references to the accompanying drawings, which form a part of the Detailed Description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim are still deemed to fall within the scope of that claim. Moreover, in the following claims, the terms “first,” “second,” “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein, as embodiments may feature a subset of said features. Further, embodiments may include fewer features than those disclosed in a particular example. Thus, the following claims are hereby incorporated into the Detailed Description, with each claim standing on its own as a separate embodiment. The scope of the embodiments disclosed herein is to be determined with reference to the appended claims, along with the full scope of equivalents to which such claims are entitled.

What is claimed is:

1. An event schedule optimizer system, the system comprising:
a user interface to:
receive data input from an organizer; and
provide data output to the organizer;
an invitees extractor to generate an intended invitees list including intended invitees for a target event based on the data input from the organizer;
a time optimizer to determine an optimal time period for the target event based on a list of historical events of the organizer; and
a place optimizer to determine an optimal place for the target event based on a set of proposed times and the list of historical events of the organizer.

2. The system of claim 1, wherein the invitees extractor's generating the intended invitees list is further based on a list of historical events of the organizer, and
further comprising an inference engine to infer one or more intended invitees from the list of historical events of the organizer based on the data input from the organizer.

3. The system of claim 2, further comprising a candidate schedule scorer to determine a score associated with each of a plurality of candidate invitees from the list of historical events of the organizer, the candidate invitees to be considered as candidates for the intended invitees list.

4. The system of claim 1, wherein the time optimizer is further to, for each of the intended invitees, generate a histogram of times for historical events of the organizer including the intended invitee.

5. The system of claim 1, further comprising an inference engine to infer one or more candidate event time periods based on the list of historical events of the organizer.

6. The system of claim 5, wherein the time optimizer's determining the optimal time period for the target event is further based on a schedule of prospective events of the organizer and a schedule of prospective events of each of the intended invitees of the intended invitees list, and the time optimizer is further to determine the one or more proposed times based on an intersection of available time periods in each of the organizer's schedule of prospective events, each of the intended invitees' schedule of prospective events, and the one or more inferred candidate event time periods.

7. The system of claim 1, wherein the place optimizer's determining the optimal place is also based on the intended invitees list.

8. The system of claim 7, further comprising an inference engine to infer one or more proposed places from the historical events of the organizer that include one or more of the intended invitees of the intended invitees list.

9. The system of claim 7, further comprising an inference engine to infer one or more proposed places from a schedule of prospective events of the organizer.

10. The system of claim 7, further comprising an inference engine to infer a semantic place from ambiguous data input from the organizer.

11. The system of claim 1, wherein the place optimizer's determining the optimal place is also based on a current location of the organizer.

12. A method of optimizing an event schedule, the method comprising:
generating an intended invitees list including intended invitees for a target event based on input from an organizer;
determining an optimal time period for the target event based on a list of historical events of the organizer;
determining an optimal place for the target event based on a set of proposed times and the list of historical events of the organizer; and
presenting a set of proposed event schedules including the intended invitees, the optimal time period, and the optimal place to the organizer.

13. The method of claim 12, wherein generating the intended invitees list is further based on the list of historical events of the organizer and includes inferring one or more of the intended invitees from the list of historical events of the organizer based on the input from the organizer.

14. The method of claim 13, wherein inferring the one or more intended invitees from the list of historical events of the organizer includes determining a score associated with each of a plurality of candidate invitees from the list of historical events of the organizer, the candidate invitees to be considered as candidates for the intended invitees list.

15. The method of claim 12, wherein determining the optimal time period for the target event includes inferring one or more candidate event time periods based on the list of historical events of the organizer.

16. The method of claim 15, wherein determining the optimal time period for the target event is also based on a schedule of prospective events of the organizer and a schedule of prospective events of each of the intended invitees of the intended invitees list and includes determining the one or more proposed times based on an intersection of available time periods in each of the organizer's schedule of prospective events, each of the intended invitees' schedule of prospective events, and the one or more inferred candidate event time periods.

17. The method of claim 12, wherein determining the optimal place is also based on the intended invitees list.

18. The method of claim 17, wherein determining the optimal place includes inferring one or more proposed places from the historical events of the organizer that include one or more of the intended invitees of the intended invitees list.

19. The method of claim 12, wherein determining the optimal place includes inferring a semantic place from ambiguous input from the organizer.

20. At least one machine-readable medium including instructions, which when executed by a machine, cause the machine to perform operations comprising:
generating an intended invitees list including intended invitees for a target event based on input from an organizer;
determining an optimal time period for the target event based on a list of historical events of the organizer;
determining an optimal place for the target event based on a set of proposed times and the list of historical events of the organizer; and
presenting a set of proposed event schedules including the intended invitees, the optimal time period, and the optimal place to the organizer.

21. The machine-readable medium of claim 20, wherein generating the intended invitees list is further based on the list of historical events of the organizer and includes inferring one or more of the intended invitees from the list of historical events of the organizer based on the input from the organizer.

22. The machine-readable medium of claim 21, wherein inferring the one or more intended invitees from the list of historical events of the organizer includes determining a score associated with each of a plurality of candidate invitees from the list of historical events of the organizer, the candidate invitees to be considered as candidates for the intended invitees list.

23. The machine-readable medium of claim 20, wherein determining the optimal place includes inferring one or more proposed places from a schedule of prospective events of the organizer.

24. The machine-readable medium of claim 20, wherein determining the optimal place is also based on a current location of the organizer.

25. The machine-readable medium of claim 20, wherein determining the optimal time period for the target event includes, for each of the intended invitees, generating a histogram of times for historical events of the organizer including the intended invitee.
